(19) United States
(12) Patent Application Publication
(10) Pub. No.: US 2010/0054183 A1
(43) Pub. Date: Mar. 4, 2010

(54) SENSOR NETWORK CONTROL METHOD FOR DATA PATH ESTABLISHMENT AND RECOVERY AND SENSOR NETWORK THEREFOR

(75) Inventors: Dong-Ryeol Shin, Gunpo-si (KR); Choon-Sung Nam, Seoul (KR); Hee-Jin Jeong, Suwon-si (KR); Yoe-Jin Yoon, Gongju-si (KR); Gun-Ha Lee, Samcheok-si (KR); Sung-Jun Na, Suseo-dong (KR); Jong-Wan Yoon, Daegu (KR); Sang-Min Lee, Suwon-si (KR); Dong-Guen Kim, Suwon-si (KR); Seung-Hyun Lee, Seoul (KR); Kee-Hyun Choi, Suwon-si (KR); Yi-Seok Jeong, Busan (KR); Hyun-Chul Kim, Gunpo-si (KR); Sang-Hwan Ryu, Uiwang-si (KR)

Correspondence Address: LEXYOUME IP GROUP, LLC, 5180 PARKSTONE DRIVE, SUITE 175, CHANTILLY, VA, 20151, US

(73) Assignee: SUNGKYUNKWAN UNIVERSITY FOUNDATION FOR CORPORATE COLLABORATION, Suwon-si (KR)

(21) Appl. No.: 12/325,441

(22) Filed: Dec. 1, 2008

(30) Foreign Application Priority Data
Aug. 29, 2008 (KR) 10-2008-0085013

(51) Int. Cl. H04W 40/02

(52) U.S. Cl. 370/328

(57) ABSTRACT

Disclosed herein are a sensor network control method for data path establishment and recovery and a sensor network therefor. The sensor network control method includes the steps of (a) the sink node or a first sensor node creating an interest message, including information about a hop count between itself and the sink node, and transmitting the interest message to one or more neighboring nodes; (b) a second sensor node, which has received the interest message, creating a routing table using the hop count information of the interest message and information about the node having transmitted the interest message, (c) the second sensor node determining a data transmission path for data transmission to the sink node using the routing table; and (d) the second sensor node transmitting an interest message, including information about a hop count between itself and the sink node to at least one neighboring node.

### BACKGROUND OF THE INVENTION

1. Field of the Invention

The present invention relates generally to a sensor network control method for data path establishment and recovery and a sensor network therefor, and, more particularly, to a path establishment and recovery technique for sensor nodes for which changes in path frequently occur.

2. Description of the Related Art

A sensor network refers to a network that is configured to sense analog data, such as sound, light and motion in three dimensional space, using sensor nodes widely distributed throughout a space and transfer the sensed data to a base station or a sink node.

Each sensor node may be generally configured to include a microcontroller, a memory unit, a second module, an output module, and a communication module. A sensor node having the above-described construction converts analog data generally sensed in physical space into digital data, and transfers the resulting digital data to a sink node. Furthermore, the sink node which received the digital data from a plurality of sensor nodes transfers the digital data to an external network, thereby providing data about a sensed event to a user.

As described above, each sensor node transfers sensed information about a surrounding environment to the sink node, and the sink node can provide the relevant information to an external user via an existing communication network such as the Internet. It is expected that a variety of applications can be implemented though such a sensor network.

When a sensor network is constructed, sensor nodes are arbitrarily deployed throughout a specific area. After the deployment, the sensor nodes perform an operation of constructing a wireless network amongst themselves.

That is, the sensor nodes collect information about the construction of a network from the sink node. In detail, each sensor node collects state information in an area under the charge thereof, and transfers the collected data to the sink node over a wireless channel. Since the transmission of data from such a sensor node to the sink node is performed through multi-hop paths, an ad-hoc network must be constructed between the sensor nodes and the sink node. In the ad-hoc network constructed as described above, the sensor nodes can transmit data to the sink node.

Since the batteries of the sensor nodes of the ad-hoc network can be replaced, there are relatively few limitations attributable to energy consumption. However, the nodes of the sensor network have many limitations related to the self-construction of a network and the transmission of data based on the constructed network. In particular, there is a problem in that it is difficult to apply the path establishment technique and data transfer technique being used in an ad-hoc network to an actual sensor network.

Furthermore, when a sensor node enters a state in which data cannot be transferred, a path reestablishment technique and the like are currently unsatisfactory according to a typical sensor network configuration method. Accordingly, there is the need for consideration to be given to a method for data transmission path reestablishment in response to a change in the environment, such as the failure of a sensor node or the entry of a sensor node into a sleep state.

### SUMMARY OF THE INVENTION

Accordingly, the present invention has been made keeping in mind the above problems occurring in the prior art, and an object of the present invention is to provide a sensor network control method and a sensor network therefor in which each sensor node of the sensor network constructs one or more routing tables for one or more neighboring nodes, establishes a path through which sensing data will be efficiently transferred between another node and itself using the routing tables, and reestablishes a data path through which data will be transferred in response to the variation in the system environment.

According to an aspect of the present invention, there is provided a method of controlling a sensor network including a sink node and one or more sensor nodes, the method including the steps of (a) the sink node or a first sensor node creating an interest message, including information about a hop count between itself and the sink node, and transmitting the interest message to one or more neighboring nodes; (b) a second sensor node, which has received the interest message, creating a routing table using the hop count information of the interest message and information about the node having transmitted the interest message; (c) the second sensor node determining a data transmission path for data transmission to the sink node using the routing table; and (d) the second sensor node transmitting an interest message, including information about a hop count between itself and the sink node to at least one neighboring node.

The routing table may include the ID of a neighboring node, information about the data transmission availability of the neighboring node, a hop count between the sink node and the neighboring node, and information about the priority of data transmission of the neighboring node. Step (c) may include the second sensor node establishing a path to a neighboring node having the lowest hop count to the sink node in the routing tables as the data transmission path.

The method may further include the steps of (d) a specific sensor node transmitting a sleep state entry message to its neighboring node prior to entering into a sleep state; and (e) the sensor node, which has received the sleep state entry message, reestablishing its data transmission path.

Step (e) may include the steps of the sensor node, which has received the sleep state entry message, setting the sensor node, which transmitted the sleep state entry message, to a transmission unavailable state; and the sensor node, which has received the sleep state entry message, reestablishing a path to a neighboring node having a lowest hop count to the sink node, which belongs to transmission available neighboring nodes, as a data transmission path.

The method may further include the steps of (f) the specific sensor node transmitting an interest message to one or more neighboring nodes in response to a request of the sink node or after an elapse of a predetermine period of time, and determining a neighboring node having no response to the interest message to be a failed node; (g) a third sensor node, having sensed the failed node, transmitting a path recovery request message including ID information of the failed node to the neighboring nodes; (h) fourth sensor nodes, having received the path recovery request message, setting the failed node to a transmission unavailable state; and (i) the fourth sensor nodes reestablishing a path to a neighboring node having a lowest hop count to the sink node, which belongs to transmission available neighboring nodes, as a data transmission path.

The method may further include the steps of (j) each of the fourth sensor nodes determining whether its original data transmission path is a path to the failed node; and (k) if the its own data transmission path is not the path to the failed node, the fourth sensor node transmitting a path recovery request message to the neighboring nodes except for the third sensor node.

According to another aspect of the present invention, there is provided a sensor network including a sink node and one or more sensor nodes, including the sink node creating an interest message, including information about a hop count between itself and the sink node, and transmitting the interest message to at least one neighboring node; each sensor node, having received the interest message, creating a routing table using the hop count information of the interest message and information about the node having transmitted the interest message, determining a data transmission path for data transmission to the sink node using the routing table, and transmitting an interest message, including information about a hop count between itself and the sink node to one or more neighboring nodes.

The routing table may include the ID of the neighboring node, information about the data transmission availability of the neighboring node, a hop count between the sink node and the neighboring node, and information about the priority of data transmission of the neighboring node. The sensor node establishes a path to a neighboring node having the lowest hop count between itself and the sink node in the routing tables as the data transmission path.

The specific sensor node may transmit a sleep state entry message to its neighboring node prior to entering into a sleep state. When the sensor node has received the sleep state entry message, the sensor node sets the sensor node, which transmitted the sleep state entry message, to a transmission unavailable state, and reestablishes a path to a neighboring node having the lowest hop count to the sink node, which belongs to transmission available neighboring nodes, as a data transmission path. The sensor node may transmit an interest message to one or more neighboring nodes in response to a request of the sink node or after an elapse of a predetermine period of time, determine a neighboring node having no response to the interest message to be a failed node, and transmit a path recovery request message, including ID information of the failed node, to the neighboring nodes. When the sensor nodes have received the path recovery request message, the sensor nodes may set the failed node to a transmission unavailable state, and reestablish a path to a neighboring node having a lowest hop count to the sink node, which belongs to transmission available neighboring nodes, as a data transmission path. When a data transmission path of the sensor node is not the path to the failed node, the sensor node may transmit a path recovery request message to the neighboring nodes except for the sensor node having transmitted the path recovery request message.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a wireless sensor network according to an embodiment of the present invention;

FIG. 2 is a diagram showing a process in which a sink node according to the present invention transmits an interest message;

FIG. 3 is a diagram showing a process in which a sensor node according to the present invention transmits an interest message;

FIGS. 4 and 5 show a process in which interest messages are spread throughout the sensor network according to the present invention;

FIG. 6 is a diagram showing a process in which data is transmitted when an event occurs in the sensor network;

FIG. 7 is a diagram showing the process of the notification of the sleep state of a sensor node according to another embodiment of the present invention;

FIG. 8 is a diagram showing a process in which a sensor node having received a message indicative of entry into a sleep state as shown in FIG. 7 establishes an alternative path;

FIG. 9 is a diagram illustrating the disconnection of a data transmission path and the isolation of a sensor node that occur due to the failure of a sensor node;

FIG. 10 is a diagram illustrating a method of sensing whether the failure of a node has occurred using an interest message;

FIG. 11 is a diagram illustrating a method of reestablishing the transmission path of a sensor node having a path to a failed node as a data transmission path; and

FIG. 12 is a diagram illustrating a process in which data is transmitted through a data path reestablished through the path reestablishment process of FIG. 11.

### DESCRIPTION OF THE PREFERRED EMBODIMENTS

Reference now should be made to the drawings, in which the same reference numerals are used throughout the different drawings to designate the same or similar components.

A sensor network control method for data path establishment and recovery and a sensor network therefor according to the present invention will be described in detail below with reference to the accompanying drawings.

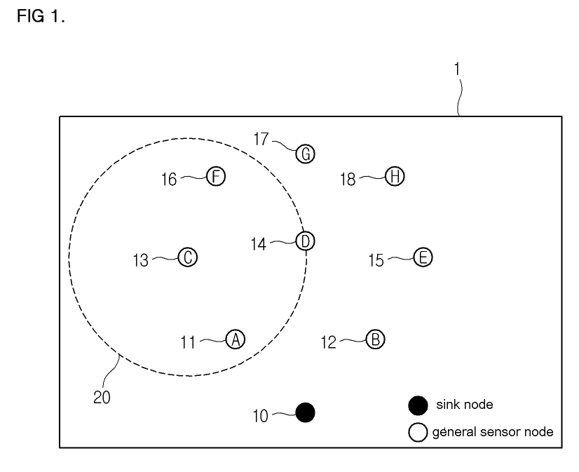

FIG. 1 is a diagram showing the construction of a wireless sensor network 1 according to an embodiment of the present invention.

As shown in FIG. 1, the wireless sensor network 1 may include a single sink node 10 and a plurality of general sensor nodes A˜G 11˜18. Among these nodes, the sink node 10 is represented by a black circle, while general sensor nodes A˜G 11˜18 are represented by white circles.

The dotted-line circle 20 shown in FIG. 1 indicates the area within which the sensor node C 13 of the general sensor nodes can directly transmit a message. The other sensor nodes 11, 12 and 14˜18 as well as the sensor node C 13 have respective limited areas within which they can directly transmit data, but the limited areas of the other sensor nodes 11, 12 and 14˜18 are not depicted in FIG. 1.

Since the data transmission distances of the sensor nodes 11˜18 are limited as described above, each of the sensor nodes C˜H 13˜18 cannot transmit data to the sink node 10 at one time. Each of the sensor nodes C˜H 13˜18 must send data to the sink node 10 via at least one sensor node. The transmission of data through two or more hops is referred to as multi-hop data transmission.

In multi-hop data transmission, the sensor nodes C˜H 13˜18 must know sensor nodes to which they can send data in order to transmit data to the sink node 10. Data transmission path management refers to work in which a sensor node determines and manages sensor nodes to which the sensor transmits data. In the following description, a technique for managing neighboring nodes to which a sensor node must transmit data in order to transmit data to a sink node will be described in greater detail.

Each of the sensor nodes 11˜18 first distributed throughout a specific area transfers the node information thereof, that is, the node ID thereof, to the other sensor nodes 11˜18 in a range within which the sensor node can transmit data. Here, the nodes located within a range within which the node under consideration can transmit data are referred to as neighboring nodes.

Furthermore, each of the sensor nodes 11˜18 includes a node state table such as Table 1 and a routing table such as Table 2.

TABLE 1
Node State Table
Node State Table

| | |
|---|---|
| Node_ID | node ID |
| Event_num | Event number occurring in node |
| Hop_cnt | hop count between sink node and |
| | node |

TABLE 2
Routing Table
Routing Table

| | |
|---|---|
| Node_ID | neighboring node ID |
| Node_valid | transmission available node |
| | state 0 or 1 |
| Hop_cnt | hop count between sink node and |
| | neighboring node |
| Node_pri | priority for data transmission |
| | to sink node |

The node state table of Table 1 is a table in which each of the general sensor nodes 11˜18 stores its own information. In contrast, the routing table of Table 2 corresponds to a table in which each of the general sensor nodes 11˜18 stores neighboring node information.

Each of the sensor nodes 11˜18 has one node state table. Meanwhile, since each of the sensor nodes 11˜18 has a plurality of neighboring nodes, it may have a plurality of routing tables such as Table 2.

The node state table of Table 1 may include a node ID field Node_ID, an event number field Event_num indicative of an event number occurring in the node, and a hop count field Hop_cnt indicative of the distance between the sink node and the node itself.

The routing table of Table 2 may include an ID field Node_ID for a neighboring node, a transmission available node state field Node_valid for the neighboring node, a hop count field Hop_cnt indicative of the distance between the neighboring node and the sink node, and node priority field Node_pri for data transmission to the sink node.

The sensor node C 13 of FIG. 1 receives the IDs of the sensor nodes 11, 14 and 16 from the nodes A, D and F 11, 14 and 16, which are the neighboring nodes of the sensor node C 13. The sensor node C 13 stores the IDs of the sensor node A, D and F 11, 14 and 16 in its routing tables, and sets the transmission available node state to ‘1’.

As a result, since the sensor node C 13 has three sensor nodes 11, 14 and 16 as its neighboring nodes, three routing tables are created.

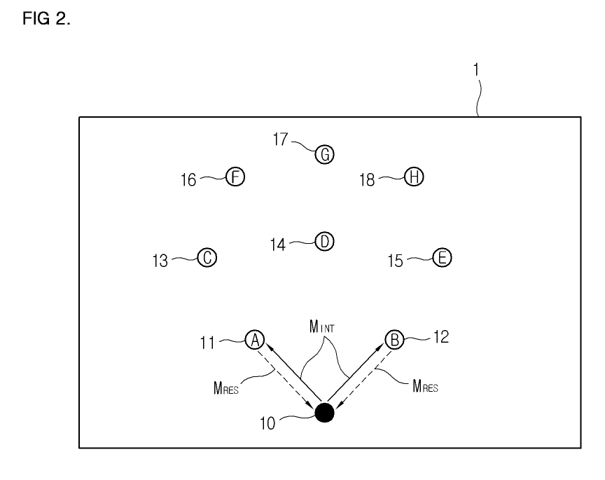

FIG. 2 is a diagram showing a process in which a sink node according to the present invention transmits an interest message.

As shown in FIG. 2, the sink node 10 creates an interest message. Information about a hop count between the node having created the interest message and the sink node is included in the interest message. In this case, the information about a hop count between the node having created the interest message and the sink node may be included in the payload of the message.

Value ‘0’ is stored in the payload of the interest message created by the sink node 10 of FIG. 2. The reason for this is that the hop count between the node and the sink node 10 is ‘0’. The interest message M_{INT} created as described above is transmitted to the sensor nodes A and B 11 and 12 located within the transmission range of the sink node 10.

The sensor nodes A and B 11 and 12 create and update routing tables, such as Table 2, using the interest message received from the sink node 10.

That is, the sensor nodes A and B 11 and 12 extract the ID of the node having transmitted the interest message and the hop count information. The routing tables, such as Table 2, are searched for based on the ID of the node having transmitted the message, which is included in the extracted information. If there is no routing tables corresponding to the ID of the node having transmitted the message, the sensor nodes A and B 11 and 12 may create routing tables, as illustrated in FIG. 1.

When routing tables are newly created or tables corresponding to the ID of the node having transmitted the interest message are found, the sensor nodes A and B 11 and 12 store the extracted hop count information in the hop count fields of the created or found routing tables, indicative of the hop count between the sink node and the neighboring nodes.

After creating and updating the routing tables, the sensor nodes A and B 11 and 12 perform the task of establishing data paths to the sink node 10. In detail, each of the sensor nodes A and B 11 and 12 determines the node having the lowest hop count between the sink node and the relevant neighboring node in its own routing table to be the node to which data will be transmitted.

In the example of FIG. 2, the sensor nodes A and B 11 and 12 determine paths to the sink node 10 as data transmission paths. The reason for this is that the hop counts between the sink node and the neighboring nodes are ‘0’, that is, the lowest value, in the routing tables corresponding to the sink node 10.

After determining the data transmission paths, the sensor nodes A and B 11 and 12 mark the node priority fields for data transmission to the sink node in the routing tables for the sink node 10 with the highest value.

Thereafter, the sensor nodes A and B 11 and 12 update the hop count fields indicative of hop counts between the sink node 10 and themselves in their node state tables such as Table 1. In this case, the hop count between the node to which the sensor nodes A and B 11 and 12 will transmit data and the sink node is ‘0’, the sensor nodes A and B 11 and 12 set ‘1’, which is higher than ‘0’ by 1, as the hop count between the sink node 10 and themselves 11 and 12.

After the above-described establishment of the data transmission paths is completed, the sensor nodes A and B 11 and 12 transmit response messages MRES providing notification of the fact that they have set the data transmission paths to the sink node 10.

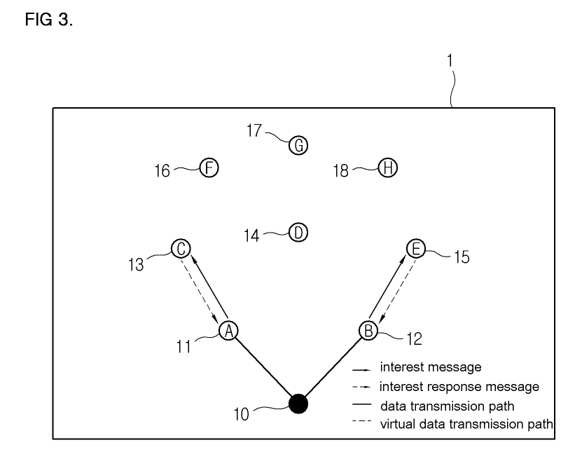

FIG. 3 is a diagram showing a process in which a sensor node according to the present invention transmits an interest message.

As illustrated in FIG. 2, the node that transmits a first interest message is the sink node 10. Meanwhile, sensor nodes capable of receiving the interest message from the sink node 10 are only the sensor nodes A and B 11 and 12. In order to establish the data transmission paths of all the sensor nodes 11˜18, the sensor nodes A and B 11 and 12 complete the establishment of their own data paths, and then transmit interest messages to their neighboring sensor nodes.

Here, the ID of the node transmitting the interest message and information about a hop count between the node having created the interest message and the sink node are included in the interest message that is transmitted by each of the sensor nodes A and B 11 and 12.

In the example of FIG. 3, the ID of the sensor node A and the hop count between the sensor node A and the sink node 10, that is, value ‘1’, are included in the interest message created by the sensor node A 11. It is apparent that the hop count information may be inserted into the payload of the interest message.

The interest messages are transferred to neighboring nodes except for the nodes of the data transmission paths determined in FIG. 2. That is, the sensor node A 11 of FIG. 3 transmits the interest message to the neighboring nodes except for the sink node 10, that is, the sensor nodes B and C 12 and 13. In the same manner, the sensor node B 12 of FIG. 3 transmits the interest message to the neighboring nodes except for the sink node 10, that is, the sensor nodes A and E 11 and 15.

In this case, the sensor nodes C and E 13 and 15 create and update routing tables using the method illustrated in FIG. 2. The sensor nodes C and E 13 and 15 create and update the routing tables, and then establish data paths that will be used to transmit data to the sink node.

Only the process of the data path establishment of the sensor node C 13 will be described in detail below. The sensor node C 13 receives the interest message from the sensor node A 11. The sensor node C 13 extracts the ID of the sensor node A 11 and information about a hop count between the sensor node A 11 and the sink node 10 from the interest message.

The sensor node C 13 may create or search for a routing table corresponding to the ID of the sensor node A 11. The sensor node C 13 stores the extracted information about the hop count between the hop count sensor node A 11 and the sink node 10 in the hop count field of the created or found routing table, indicative of the hop count between the sink node and the neighboring node.

After updating the routing table as described above, the sensor node C 13 determines a data transmission path. A neighboring node having the lowest hop count between the sink node 10 and the relevant neighboring node in the current routing table is set as a node to which data will be transmitted. In the example of FIG. 3, the sensor node C 13 determines the sensor node A 11 having hop count ‘1’ to be a node to which data will be transmitted.

Thereafter, the sensor node C 13 updates the hop count field of its own node state table, indicative of the hop count between the sink node 10 and itself, with value ‘2’. Furthermore, the sensor node C 13 transmits a response message, providing notification of the fact that it has set the path to the sensor node A 11 as the data transmission path, to the sensor node A.

Meanwhile, in FIG. 3, the facts that the sensor node A 11 transmits the interest message to the sensor node B 12 and the sensor node B 12 transmits the interest message to the sensor node A 11 should be noted. This occurs because the sensor nodes A and B 11 and 12 are neighboring nodes.

In this case, the sensor nodes A and B 11 and 12 also create and update routing tables for the neighboring nodes 12 and 11. After creating and updating the routing tables, the sensor nodes A and B 11 and 12 may reestablish data paths.

That is, each of the sensor nodes A and B 11 and 12 establishes a neighboring node having the lowest hop count between the sink node and the relevant neighboring node in the routing table as a node to which data will be transmitted.

In this case, since a neighboring node having the lowest hop count in the routing tables for the sensor nodes A and B 11 and 12 is the sink node 10, the sensor nodes A and B 11 and 12 of FIG. 3 do not change the data transmission paths. Accordingly, each of the sensor nodes A and B 11 and 12 sets the priority value of the neighboring sensor node B or A 12 or 11 to a value lower than the highest value.

As described above, the sensor nodes A and B 11 and 12 may set directionality in the establishment of data transmission paths. Even when interest messages are received from a plurality of nodes, a path to a neighboring node having the lowest hop count may be used as a data transmission path.

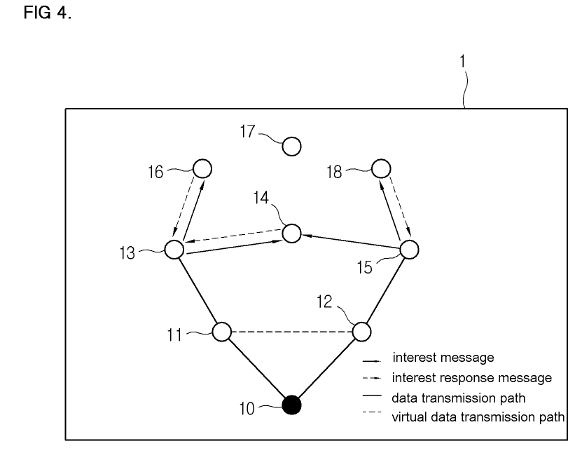

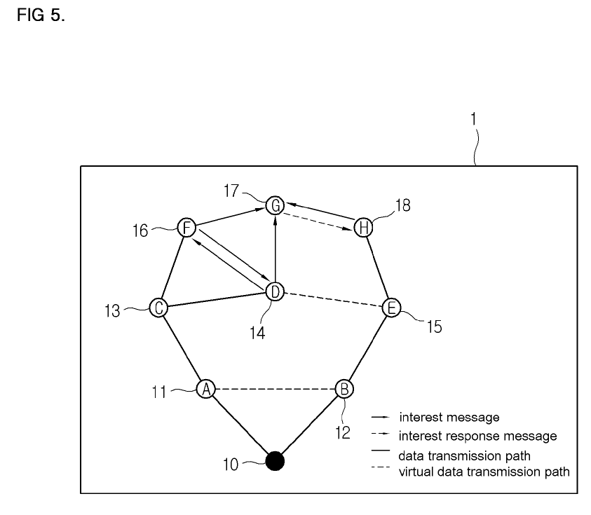

FIGS. 4 and 5 show a process in which interest messages are spread throughout the sensor network according to the present invention.

FIG. 4 illustrates the operation when interest messages arrive almost simultaneously at a single sensor node. Currently, the sensor node D 14 of FIG. 4 may almost simultaneously receive an interest message transferred through the path of the sink node 10—the sensor node A 11—the sensor node C 13 and an interest message transferred through the path of the sink node 10—the sensor node B 12—the sensor node E 15.

As described above, the sensor node D 14 extracts information from each of the interest messages, and creates and updates routing tables. However, the two interest messages all have value ‘2’ as information about hop counts to the sink node 10. Accordingly, the sensor node D 14 cannot determine one data transmission path using only the information about hop counts to the sink node 10.

In such a situation, a method of giving priority to a data transmission path having an earlier interest message arrival time may be used. Assume that the sensor node D 14 of FIG. 4 receives the interest message transferred through the path of the sink node 10—the sensor node A 11—the sensor node C 13 prior to receiving the interest message transferred through the path of the sink node 10—the sensor node B 12—the sensor node E 15.

In this case, the sensor node D 14 determines that data will be transmitted to the sensor node C 13. Accordingly, the sensor node D 14 sets the priority value of a routing table for the sensor node C 13 to the highest value, and sets the priority value of a routing table for the sensor node E 15 to a value lower than the highest value.

After determining the data transmission path as described above, the sensor node D 14 provides notification of the establishment of the data path only to the sensor node C 13.

A situation similar to that in the sensor node D 14 of FIG. 4 occurs in the sensor node G 17 of FIG. 5. The sensor node G 17 receives interest messages from sensor nodes D, F and H 14, 16 and 18.

Furthermore, information about hop counts to the sink node 10 included in the interest messages all has value ‘3’. In this case, the sensor node G 17 establishes a path to a neighboring node having transmitted the earliest interest message as a data transmission path.

In FIG. 5, it is assumed that the sensor node G 17 has received an interest message from the sensor node H 18 earliest. Accordingly, it can be seen that the sensor node G 17 selects the sensor node H 18 as a neighboring node to which data will be transmitted. It is apparent that the sensor node G 17 provides notification of this to the sensor node H 18 to which data will be transferred.

Meanwhile, in FIG. 5, interest messages are exchanged between the sensor node D 14 and the sensor node F 16. In this case, the sensor node pair D-F performs an operation similar to that of the sensor nodes A and B 11 and 12 of FIG. 3.

For example, the sensor node F 16 receives an interest message from the sensor node D 14, and information about a hop count to the sink node included in the interest message is ‘3’. However, the sensor node F 16 has a routing table for the sensor node C 13, in which information about a hop count to the sink node is ‘2’.

Accordingly, the sensor node F 16 maintains a path to the sensor node C 13 having a lower hop count as a data transmission path. Meanwhile, the sensor node F 16 manages routing tables by decreasing the priority of the sensor node D 14 to a value lower than the priority of the sensor node C 13. The reason way an unused routing table is managed as described above is that a managed path can be used as an alternative path when the sensor node C 13 is non-operational.

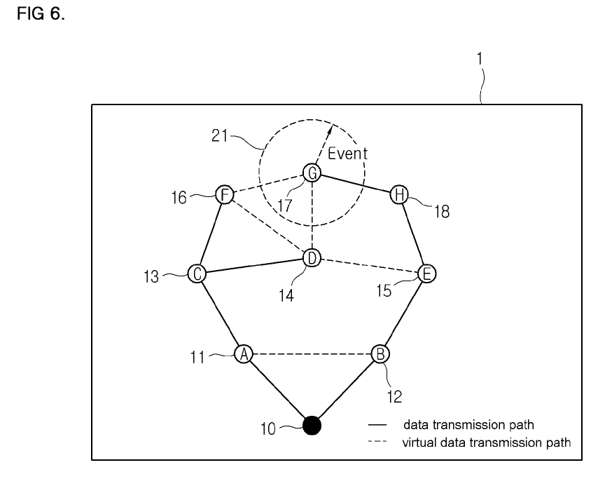

FIG. 6 is a diagram showing a process in which data is transmitted when an event occurs in the sensor network.

Assume that a specific event occurs in the dotted line area shown in FIG. 6. In this case, the sensor node G 17 present in the dotted line area senses the occurring event.

The sensor node G 17 creates a report including data about the type of event, the time when the event occurred and the duration of the event. The sensor node G 17 transmits the created report to the sink node 10, in which case the data transmission paths established in FIGS. 1 to 6 may be used.

That is, the sensor node G 17 transmits data to the sensor node H 18 having the highest value among neighboring nodes. In the same manner, the sensor node H 18 transmits data to the sensor node E 15 having the highest priority. When this process is repeated, the data is transmitted through the path of the sensor node G 17—the sensor node H 18—the sensor node E 15—the sensor node B 12—sink node 10.

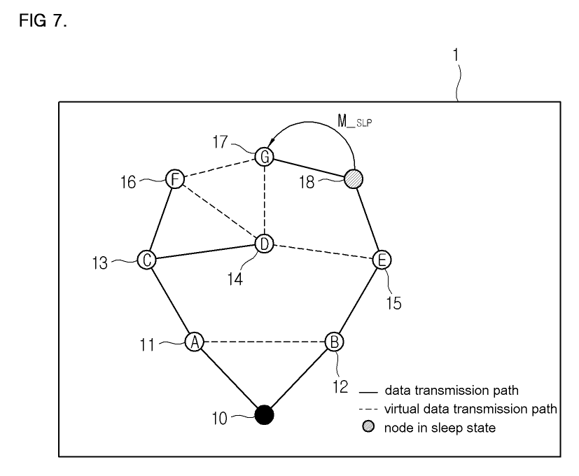

FIG. 7 is a diagram showing the process of the notification of the sleep state of a sensor node according to another embodiment of the present invention.

Immediately prior to entering a sleep state, the sensor node H 18 transmits a sleep state entry message M_{—SLP} notifying the node G 17, which will transfer data to itself, of entry into the sleep state and providing notification of the change in data transmission path.

The sleep state entry message can prevent data transfer from looping by enabling only nodes having set the sensor node entering into a sleep state as a priority node, a node having set a node itself as a priority node, and a node having a higher hop count to respond.

As illustrated in FIG. 7, the sensor node H 18 entering a sleep state provides notification of its entry into the sleep state to a node that transfers data to the sensor node H 18, that is, the sensor node G 17. The sensor node G 17 having received a message indicative of the entry into the sleep state establishes an alternative path using a stored routing table.

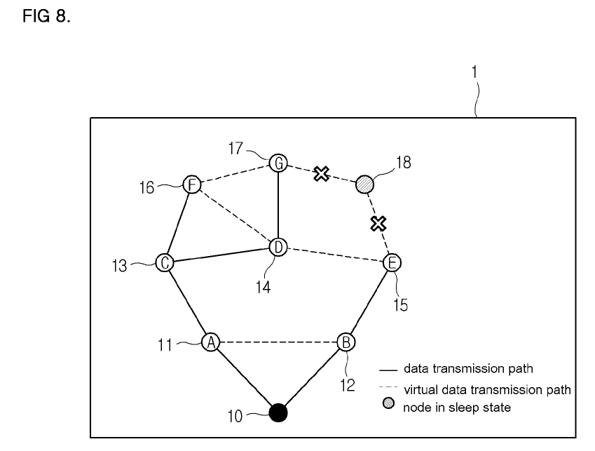

FIG. 8 is a diagram showing a process in which a sensor node having received a message indicative of entry into a sleep state as shown in FIG. 7 establishes an alternative path.

The sensor node G 17 having received the transferred sleep state message as shown in FIG. 7 may set the transmission available state of a routing table for the sensor node H 18 to which data has been transmitted to ‘0’, and may set the transmission priority of the sensor node H 18 to the lowest value.

Thereafter, the sensor node G 17 selects a neighboring node having the lowest hop count to the sink node 10 from among neighboring nodes having transmission available state ‘1’. The sensor node G 17 resets the transmission priority of the selected neighboring node to the highest value.

In the example of FIG. 7, among the neighboring nodes of the sensor node G 17, the sensor nodes D and F 14 and 16 are neighboring nodes having transmission available state ‘1’. The hop counts between the sensor nodes D and F 14 and 16 to the sink node 10 are all ‘3’. Accordingly, the sensor node G 17 may determine a sensor node from which an interest message has been received earliest and then establish a data transmission path.

The example of FIG. 7 is the case where the sensor node G 17 receives an interest message from the sensor node D 14 earliest and reestablishes a path to the sensor node D 14 as a data transmission path. When an event occurs after the data transmission path has been reestablished, the sensor node G 17 transmits an event report to the sink node 10 through the sensor node D 14.

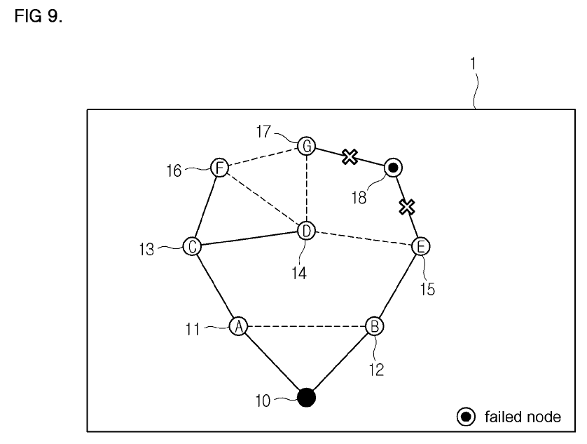

A method of establishing the transmission paths of neighboring nodes when a general sensor node fails according to another embodiment of the present invention will be described below with reference to FIGS. 9 to 12.

The failure of the sensor node described in FIGS. 9 to 12 refers to the non-operational state of the sensor node in a situation in which the sensor node cannot provide advance notice to neighboring nodes due to causes such as an external physical cause or the energy exhaustion of the sensor node itself.

FIG. 9 is a diagram illustrating the disconnection of a data transmission path and the isolation of a sensor node that occur due to the failure of the sensor node.

When the sensor node H 18 fails, the sensor nodes E and G 15 and 17, a neighboring node of which is the sensor node H 18, lose a node to or from which data is transferred or received. Accordingly, the disconnection of data paths and the isolation of sensors node occur around the failed sensor node H 18.

From FIG. 9, it can be seen that due to the failure of the sensor node H 18, a data transmission path from the sensor node G 17 to the sensor node H 18 and a data transmission path from the sensor node H 18 to the sensor node E 15 are disconnected.

In particular, unlike the node in FIGS. 7 and 8, the sensor node G 17 does not receive any notice from the sensor node H 18, so that the sensor node G 17 transmits data to the sensor node H 18 when an event occurs. In this case, since the sensor node H 18 cannot operate normally, the transmission of data to the sink node 10 results in repeated failures. As a result, there arises a problem in that the normally operating sensor node G 17 is also isolated in the data transmission path.

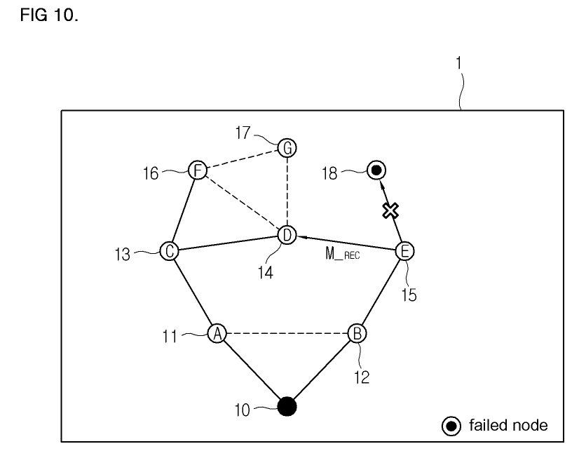

FIG. 10 is a diagram illustrating a method of sensing whether the failure of a node has occurred using an interest message.

As described above, when a sensor node transfers an interest message, neighboring nodes having set the sensor node as a data transmission node transmit responses to the sensor node that transferred the interest message.

However, when the neighboring node is a failed node, the sensor node having transferred the interest message cannot receive a response to the interest message from the neighboring node. A failed sensor node can be sensed using the above-described feature.

In FIG. 10, the sensor node H 18 establishes a path to the sensor node E 15 as a data transmission path. Accordingly, the failure of the sensor node H 18 can be checked by the sensor node E 15. That is, the sensor node E 15 transmits an interest message to the sensor node H 18 in response to the request of a sensor network administrator or after the elapse of a predetermined period of time. When there is no response to the interest message, the sensor node E 15 senses the failure of the sensor node H 18.

In this case, the sensor node E 15 having sensed the failure of the sensor node H 18 transmits a path recovery request message M_{—REC} to the other neighboring nodes. The ID of the failed sensor node H 18 is present in the path recovery request message.

Sensor nodes having received the path recovery request message determine whether the sensor node having transmitted the path recovery request message has been set as a priority sensor node. It will be apparent that the determination can be performed by comparing the hop count of a sensor node to which data is currently transmitted with the hop count of a sensor node which transmitted the recovery request message.

The above process is repeated until the path recovery request message is transferred to a node having the failed node as a priority node. In the present embodiment, the sensor node E 15 transfers new path reestablishment to the sensor node D 14, which is a neighboring node thereof.

The sensor node D 14 having received the path recovery request message reestablishes a path by comparing the hop count of the sensor node C 13 currently having priority with the hop count of the sensor node E 15 having transferred the path recovery request message on the basis of routing tables.

Thereafter, the sensor node D 14 transfers the path recovery request message to the neighboring nodes C, F and G 13, 16 and 17 thereof. This process may be repeated until the sensor node G 17 having the failed node as a priority node receives the path recovery request message.

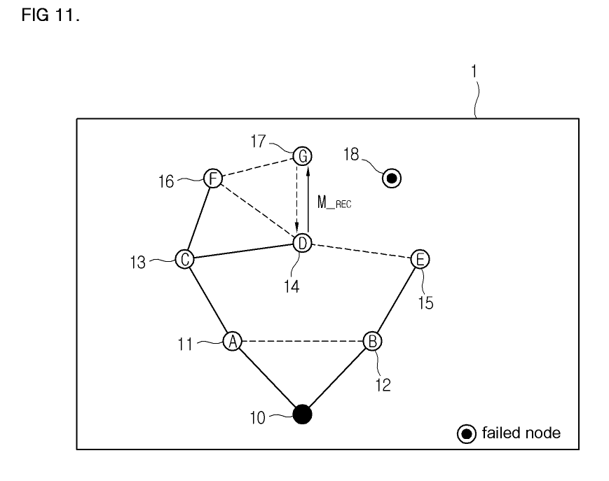

FIG. 11 is a diagram illustrating a method of reestablishing the transmission path of a sensor node having a path to a failed node as a data transmission path.

The sensor nodes having received the path recovery request message search the routing tables thereof for the ID of the failed node. Thereafter, the sensor nodes set the transmission available node state of the failed node to ‘0’, and also set the priority of the failed node to the lowest value.

Thereafter, each sensor node having set the failed node to a priority node corrects a routing table so that data transmission to a second highest priority sensor node can be performed. Through this process, the sensor nodes can create and reestablish new transmission paths and reestablish transmission paths by themselves even when the failure of a sensor node occurs.

However, in this case, the sensor nodes do not delete routing tables for the failed node. The reason for this is that the failure of the sensor node may be temporary.

In FIG. 11, the sensor node G 17 having received the path recovery request message sets the priority of the sensor node H 18 corresponding to the highest priority to the lowest value, and then performs setting so that data is transmitted to the sensor node D 14 having the second highest priority.

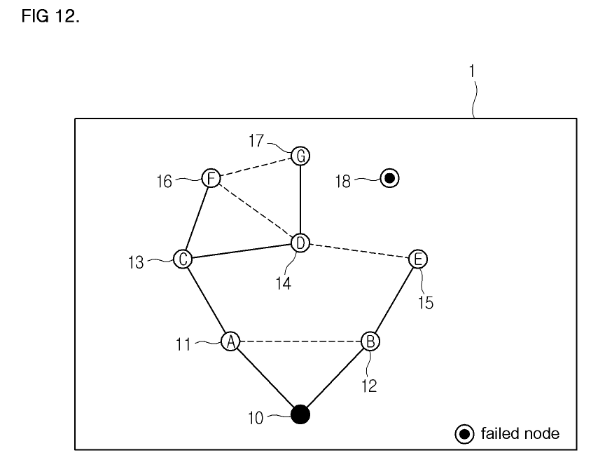

FIG. 12 is a diagram illustrating a process in which data is transmitted through a data path reestablished through the path reestablishment process of FIG. 11.

Through the process of FIGS. 9 to 11, the sensor node G 17 senses the failure of the sensor node H 18 and then reestablishes its own data transmission path. As a result, the sensor node G 17 transfers data to the sensor node D 14 when it attempts to transmit the data to the sink node 10.

Meanwhile, since the sensor node D 14 has not set the failed sensor node H 18 as a data transmission path, the sensor node D 14 does not reestablish a data path. Accordingly, the sensor node D 14 transmits data to the sensor node C 13, as in the existing method. As a result, the data transferred by the sensor node G 17 is transferred to the sink node 10 through the path of the sensor node D 14—the sensor node C 13—the sensor node A 11.

In accordance with the sensor network control method for data path establishment and recovery and the sensor network therefor according to the present invention, general sensor nodes can establish reliable data transmission paths therebetween so as to transfer data required by the sink node, and unnecessary communication with nodes can be reduced because one set path is used as a main path to transfer data. Accordingly, congestion that may occur while data is transferred over the sensor network can be avoided. Furthermore, since the unnecessary energy consumption of sensor nodes can be reduced, the energy consumption of the sensor network can be reduced.

Moreover, according to the present invention, in response to the variations in the topology of general sensor nodes, the various and active replacement of data paths can be achieved by varying and recovering data transmission paths. Through this replacement of data paths, reliable data transmission is guaranteed for the transfer of sensing data required by the sink node, so that the error of data attributable to communication failure can be reduced and the accuracy of data transmission can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling a sensor network including a sink node and one or more sensor nodes, the method comprising the steps of:
(a) the sink node or a first sensor node creating an interest message, including information about a hop count between itself and the sink node, and transmitting the interest message to one or more neighboring nodes;
(b) a second sensor node, which has received the interest message, creating a routing table using the hop count information of the interest message and information about the node having transmitted the interest message;
(c) the second sensor node determining a data transmission path for data transmission to the sink node using the routing table; and
(d) the second sensor node transmitting an interest message, including information about a hop count between itself and the sink node to at least one neighboring node.

2. The method as set forth in claim 1, wherein the routing table comprises an ID of a neighboring node, information about data transmission availability of the neighboring node, a hop count between the sink node and the neighboring node, and information about priority of data transmission of the neighboring node.

3. The method as set forth in claim 2, wherein step (c) comprises the second sensor node establishing a path to a neighboring node having a lowest hop count to the sink node in the routing tables as the data transmission path.

4. The method as set forth in claim 3, further comprising the steps of:
(d) a specific sensor node transmitting a sleep state entry message to its neighboring node prior to entering into a sleep state; and
(e) the sensor node, which has received the sleep state entry message, reestablishing its data transmission path.

5. The method as set forth in claim 4, wherein step (e) comprises the steps of:
the sensor node, which has received the sleep state entry message, setting the sensor node, which transmitted the sleep state entry message, to a transmission unavailable state; and
the sensor node, which has received the sleep state entry message, reestablishing a path to a neighboring node having a lowest hop count to the sink node, which belongs to transmission available neighboring nodes, as a data transmission path.

6. The method as set forth in claim 3, further comprising the steps of:
(f) the specific sensor node transmitting an interest message to one or more neighboring nodes in response to a request of the sink node or after an elapse of a predetermine period of time, and determining a neighboring node having no response to the interest message to be a failed node;
(g) a third sensor node, having sensed the failed node, transmitting a path recovery request message including ID information of the failed node to the neighboring nodes;
(h) fourth sensor nodes, having received the path recovery request message, setting the failed node to a transmission unavailable state; and
(i) the fourth sensor nodes reestablishing a path to a neighboring node having a lowest hop count to the sink node, which belongs to transmission available neighboring nodes, as a data transmission path.

7. The method as set forth in claim 6, further comprising the steps of:
(j) each of the fourth sensor nodes determining whether its original data transmission path is a path to the failed node; and
(k) if the its own data transmission path is not the path to the failed node, the fourth sensor node transmitting a path recovery request message to the neighboring nodes except for the third sensor node.

8. A sensor network including a sink node and one or more sensor nodes, comprising:
the sink node creating an interest message, including information about a hop count between itself and the sink node, and transmitting the interest message to at least one neighboring node;
each sensor node, having received the interest message, creating a routing table using the hop count information of the interest message and information about the node having transmitted the interest message, determining a data transmission path for data transmission to the sink node using the routing table, and transmitting an interest message, including information about a hop count between itself and the sink node to one or more neighboring nodes.

9. The sensor network as set forth in claim 8, wherein the routing table comprises an ID of the neighboring node, information about data transmission availability of the neighboring node, a hop count between the sink node and the neighboring node, and information about priority of data transmission of the neighboring node.

10. The sensor network as set forth in claim 9, wherein the sensor node establishes a path to a neighboring node having a lowest hop count between itself and the sink node in the routing table as the data transmission path.

11. The sensor network as set forth in claim 10, wherein the specific sensor node transmits a sleep state entry message to its neighboring node prior to entering into a sleep state.

12. The method as set forth in claim 11, wherein, when the sensor node has received the sleep state entry message, the sensor node sets the sensor node, which transmitted the sleep state entry message, to a transmission unavailable state, and reestablishes a path to a neighboring node having a lowest hop count to the sink node, which belongs to transmission available neighboring nodes, as a data transmission path.

13. The sensor network as set forth in claim 10, wherein the sensor node transmits an interest message to one or more neighboring nodes in response to a request of the sink node or after an elapse of a predetermine period of time, determines a neighboring node having no response to the interest message to be a failed node, and transmits a path recovery request message, including ID information of the failed node, to the neighboring nodes.

14. The sensor network as set forth in claim 13, wherein, when the sensor nodes have received the path recovery request message, the sensor nodes set the failed node to a transmission unavailable state, and reestablish a path to a neighboring node having a lowest hop count to the sink node, which belongs to transmission available neighboring nodes, as a data transmission path.

15. The sensor network as set forth in claim 14, wherein, when a data transmission path of the sensor node is not the path to the failed node, the sensor node transmits a path recovery request message to the neighboring nodes except for the sensor node having transmitted the path recovery request message.
